(19) United States
(12) Patent Application Publication
(10) Pub. No.: US 2021/0354386 A1
(43) Pub. Date: Nov. 18, 2021

(54) BUILD MATERIAL SPREADING

(71) Applicant: HEWLETT-PACKARD DEVELOPMENT COMPANY, L.P., Spring, TX (US)

(72) Inventors: Pablo Antonio Murciego Rodriguez, Sant Cugat del Valles (ES); Pau Martin Vidal, Sant Cugat del Valles (ES); Esteve Comas Cespedes, Sant Cugat del Valles (ES)

(21) Appl. No.: 16/607,867

(22) PCT Filed: Apr. 27, 2018
(86) PCT No.: PCT/US2018/029976

§ 371 Date: Oct. 24, 2019

(51) Int. Cl. B29C 64/321; B29C 64/295; B33Y 40/10; B33Y 10/00; B33Y 30/00

(52) U.S. Cl. CPC B29C 64/321; B29C 64/295; B33Y 30/00; B33Y 10/00; B33Y 40/10

(57) ABSTRACT

Mechanisms to spread build material on a print bed are disclosed. In example apparatuses a conveyor, having an endless belt, is used. A build material reservoir deposits build material on the endless belt, in a build material receiving area of the conveyor. A build material preheater is used to preheat build material transported by the endless belt in a build material preheating area of the conveyor. The preheated build material is then deposited on the print bed.

### BACKGROUND

Additive manufacturing, e.g. three dimensional (3D) printing, involves technologies where material, is selectively solidified to form a 3D object. There are many different types of 3D printing. One type involves forming thin layers of a particulate type build material, e.g. powder, and selectively solidifying portions of each layer to form a 3D object. By depositing successive layers of material it is possible to create solid objects or parts from a series of cross sections which are joined together or fused.

### BRIEF DESCRIPTION

Some non-limiting examples of the present disclosure are described in the following with reference to the appended drawings, in which:

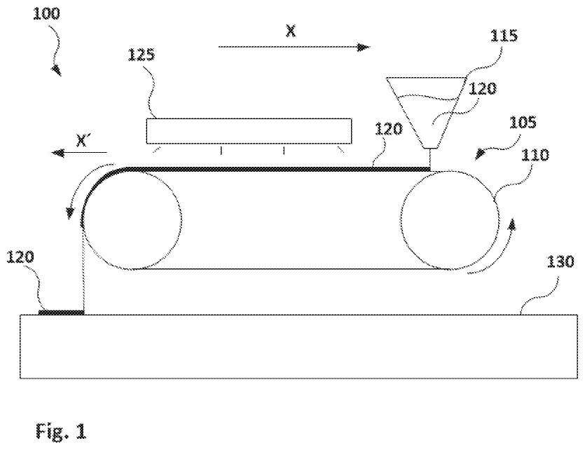

FIG. 1 schematically illustrates an apparatus to spread powder-type build material on a print bed, according to an example.

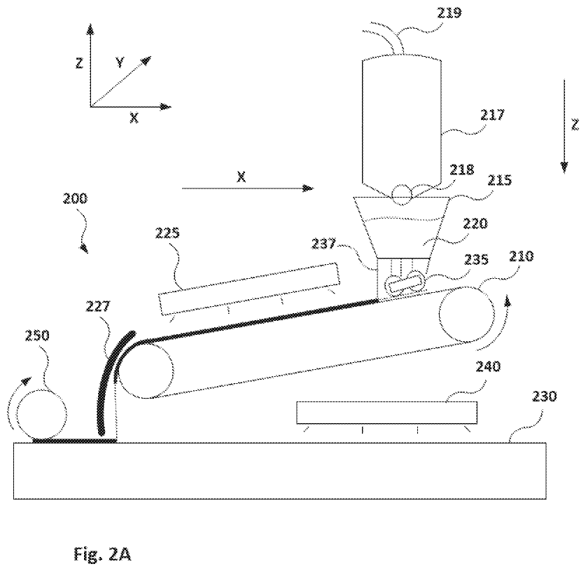

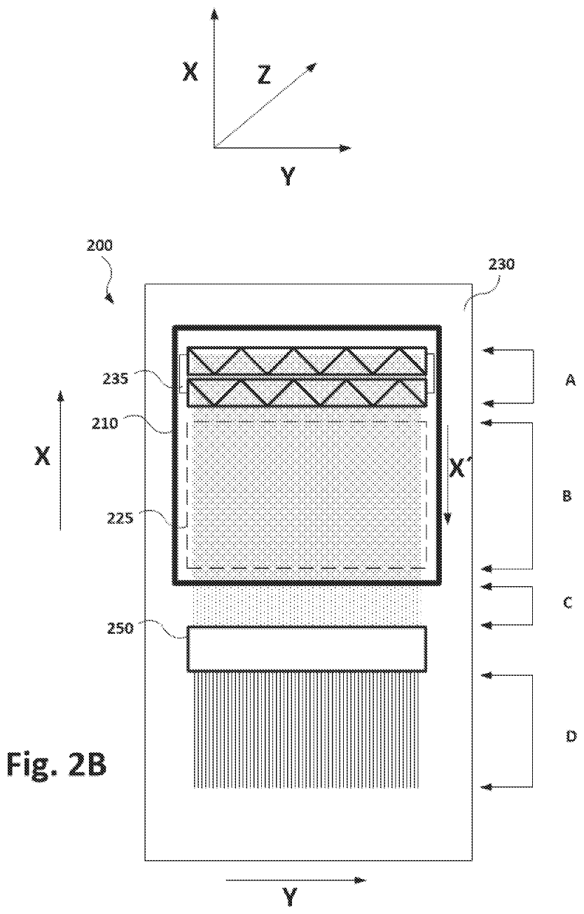

FIG. 2A schematically illustrates a side view of a powder spreading conveyor, according to an example.

FIG. 2B schematically illustrates a top view of a section of the power spreading conveyor of FIG. 2A.

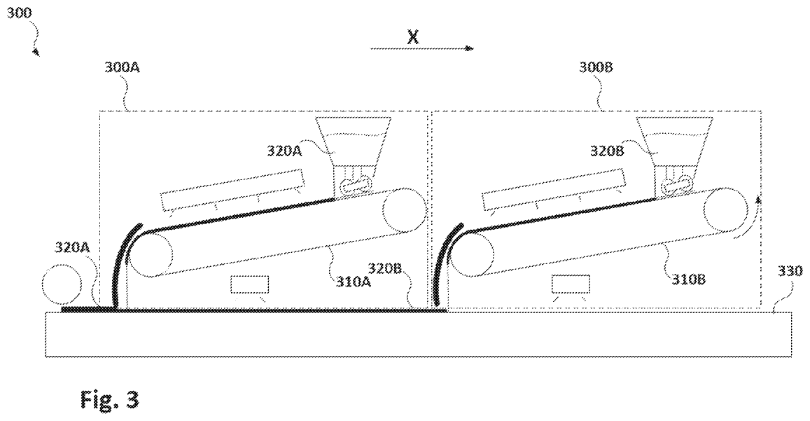

FIG. 3 schematically illustrates a 3D printer with a multiple belt system, according to an example.

### DETAILED DESCRIPTION

In some additive manufacturing processes, heat is used to fuse together the particles in a powdered build material to form a solid object. Heat to fuse the build material may be generated, for example, by applying a liquid fusing agent to a thin layer of powder in the pattern of a single slice of the object and then exposing the patterned area to a light or other energy source. The fusing agent absorbs energy to help sinter, melt or otherwise fuse the powdered build material. In some 3D printing technologies a build material, e.g. powder, block is created by depositing the build material on a build platform and the block is then spread with a recoater. The recoater may be a roller, a blade or any other recoating mechanism. The build material may be spread in a layer over the build platform and may be pre-heated to a temperature close to but below the melting point of the build material. Such pre-heating may be performed by static overhead heating lamps or by scanning warming lamps. The temperature of each previous layer may drop before another layer is deposited on top of the previous one. Thus layers of varying temperatures may be on the print bed when the solidification process or fusing starts. Furthermore, when a block of built material is deposited on the print bed to be spread by the recoater, the spreading speed may be limited by the size of the block, i.e. by the amount of built material in the block.

In one example, the build materials used to form the layers may comprise thermoplastic materials, although in other examples other materials including metals and ceramic build materials may be used. A suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

FIG. 1 schematically illustrates an apparatus to spread powder-type build material on a print bed, according to an example. Apparatus 100 comprises a conveyor 105 with a rotatable endless belt 110. The conveyor 105 may comprise pulleys (sometimes referred to as drums), and the rotatable endless belt 110 may rotate in an endless loop about the pulleys. The pulleys may be used to drive and change direction of the endless belt 110. A portion of the rotatable endless belt 110 may be facing downwards as it is driven in a first direction. It may then rise at a first edge of the conveyor and face upwards where build material may be loaded to be transported to the other edge of the conveyor where the material may be unloaded and the portion of the belt may change direction again facing downwards. The material may be loaded in a receiving area of the conveyor defined as an area after the belt portion has changed direction facing upwards. Apparatus 100 may comprise a powder reservoir 115 arranged over the receiving area of the conveyor along a portion of the width of the endless belt 110. The powder reservoir 115 may store build material 120, e.g. powder. The powder reservoir 115 may have an opening to provide printing material 120 to the receiving area of the conveyor 105, on a transporting surface of the endless belt 110, as the endless belt 110 rotates. The apparatus 100 may also comprise a powder preheater 125. The powder preheater 125 may be arranged over a power preheating area of the conveyor 100. The apparatus may be arranged over a print bed 130. During use, the apparatus 100 may be relatively moveable with respect to the print bed 130 along a first direction X. The direction X may coincide or be contrary to a component X′ of the direction of the transporting surface of the endless belt 110 as the endless belt 110 rotates. For example, when the endless belt rotates counter-clockwise, the apparatus 100 may be movable in a left to right direction, and vice versa. As the endless belt 110 rotates, print material 120 preheated with powder preheater 125 may be deposited on the print bed 130.

The proposed mechanism may create powder layers for 3D printing technologies thus allowing for improvements in layer deposition speed. As the powder is heated before being deposited, it may be applied homogeneously and efficiently with reduced amounts of energy. A more homogenous layer may be provided as powder layers are formed instead of powder blocks. Furthermore, the amount of energy used to spread the powder in a controlled manner is reduced as power layers are deposited leading to better layer quality as the recoater may find less resistance when forming the layer since the build material is not in the form of a block. As the powder is preheated before deposition, the effect of the powder deposition over previous layers on the powder bed is reduced as less energy is used to preheat the powder once on the power bed.

FIG. 2A schematically illustrates a side view of a powder spreading conveyor, according to an example. The conveyor may be mountable on a carriage of a 3D printing system. FIG. 2B schematically illustrates a top view of a section of the powder spreading conveyor of FIG. 2A. Powder spreading conveyor 200 may be relatively moveable above a print bed 230 in one direction X. The powder spreading conveyor 200 may receive powder, process it and deposit it on print bed 230. In an example, the direction X may coincide with the powder deposition direction. The power spreading conveyor 200 may comprise an endless conveyor belt 210. The endless conveyor belt 210 may be rotatable to transport powder along an axis X. The powder spreading carriage 200 may comprise a powder supply 215 arranged over a powder receiving area A of the endless conveyor belt 210. The powder supply 215 may store build material 220, e.g. powder. The powder supply 215 may have an opening to provide printing material 220 to the receiving area A of the endless conveyor belt 210, on a transporting surface of the endless conveyor belt 210, as the endless conveyor belt 210 rotates. The powder may fall freely by gravity in a direction Z over the endless conveyor belt 210 from the powder supply 215 where a spreading mechanism 235 may be placed between the powder supply 215 and the conveyor to process the powder supplied and uniformly deposit on the endless belt powder 220 received from the powder supply 215 along a portion of the width Y of the endless conveyor belt 210. The spreading mechanism 235 may be a rotating screw (also called “Archimedes screw”) spreader, a vibrating platform or an air fluidification mechanism. In the examples of FIG. 2A and FIG. 2B the spreading mechanism 235 is a rotating screws spreader 235. The rotating screws spreader 235 may comprise rotating screws. The powder may freely fall from the power supply 215 in the form of lumps. The rotating screws may disrupt the lumps and provide a fine particle supply of powder on the endless conveyor belt 210 and uniformly distribute the received powder along a portion of the width of the endless conveyor belt 210 in the direction Y. In other implementations, the spreading mechanism 235 may comprise a vibrating platform, to disperse any powder lumps. The vibrating platform may be part of the conveyor or may be attached to the conveyor. In yet other implementations the spreading mechanism may be an air fluidification mechanism. The air fluidification mechanism may blow air to any powder lumps thus providing powder in fine particle form on the endless conveyor belt. The conveyor 200 may also comprise a powder preheater 225. The powder preheater 225 may be arranged over a powder preheating area B of the endless conveyor belt 210. As the endless conveyor belt 210 rotates, print material 220 preheated with powder preheater 225 may be transferred to a deposit area of the endless conveyor belt 210 to be deposited on the print bed 230. The powder spreading carriage may comprise a spreading control element 227. The spreading control element 227 may guide the preheated powder from the endless conveyor belt 210 to the print bed 230 to avoid dispersion of powder as the powder falls off the endless conveyor belt at the end of the transporting surface. The endless conveyor belt 210 may be arranged over the print bed 230 at an angle with respect to the print bed 230. When the print bed is in a substantially horizontal position, the receiving area A of the endless conveyor belt may be higher than the preheating area B of the endless conveyor belt 210. Thus, a space may be generated below the receiving area of the endless conveyor belt 210. The powder spreading carriage 200 may further comprise print bed heater 240 to preheat the previous layers of build material before fusing. The print bed heater 240 may be located below the endless conveyor belt, e.g. in the space between endless conveyor belt 210 and print bed 230 generated by the inclined position of the endless conveyor belt 230 and may be moveable as part of the conveyor 200 or independently. The powder spreading conveyor 200 may further comprise a powder transportation control blade 237, to control a quantity of powder 220 passing from the powder receiving area A to the powder preheating area B of the conveyor. The powder transportation control blade 237 provides powder 220 to the preheating area in a controllable manner to avoid the passage of lumps of powder to the preheating area B. The conveyor belt 210 action is to carry the powder received in the powder receiving area forwards and the powder transportation control blade 237 would manage the entry of the powder in the preheating area B where the powder preheater 225, using a close loop operation, would preheat the powder to a desired temperature. The preheated powder guided by the spreading control element 227 may be deposited on the printbed 230 in an area C of the print bed 230. The powder spreading carriage 200 may also comprise a recoater 250, e.g. a roller, to smooth the surface of the deposited preheated powder. The recoater 250 may follow the powder deposition path. In that respect, the print bed heater 240 may lead the powder deposition path in the powder deposition direction to heat previously formed layers of built materials on the print bed before the next layer is spread by the recoater. The spread powder may then uniformly form the next layer as shown in area D on the print bed 230. The recoated powder in the area D may then be ready for a next layer deposition or for fusing. The powder supply 215 may be a refillable powder supply unit. It may receive powder from a powder reservoir 217 that, in turn, may receive powder from a powder feed 219. Alternatively, a powder feed 219 may provide powder directly to the refillable powder supply unit. A powder dosage element 218 may control the amount of powder 220 that may reach or fall on the powder supply 215 so that the powder supply 215 to receive and accordingly provide to the endless conveyor belt 210 powder in a controllable manner.

FIG. 3 schematically illustrates a 3D printing system with multiple belts, according to an example. The 3D printing system 300 may comprise two or more moveable in-line conveyors, e.g. conveyors 310A and 310B. The conveyors may be substantially similar to conveyors 100 and 200 discussed with reference to FIG. 1, FIG. 2A and 2B. In one implementation, a space may be generated below the receiving area of the endless conveyor belt 310A of conveyor 300A. Part of the conveyor 300B may then be placed in the space generated below conveyor 300A. Multiple materials may be placed over the same layer of print bed 330. For example, two different build materials, e.g. thermoplastic materials and/or glass fibres 320A, 320B may be dosed and processed, i.e. preheated independently by the two conveyors 300A, 300B, respectively during the same carriage action, i.e. during a powder deposition pass. For example, materials of different color may coexist in the same layer. In other implementations, the multiple belts may be moveable along the same axis but in a different direction, thus allowing for bi-directional build material deposition. For example, if two belts are used, one may be moveable along the axis X in one direction and the other along the axis X in the opposite direction. Thus the print bed may be provided with processed build material from two different directions. This may double the speed of build material deposition on the print bed. In yet other implementations, multiple belts may be employed in each direction.

By processing, e.g. preheating the powder on an endless conveyor belt before depositing on a print bed, powder thermal control and uniformity may be performed as the preheating system would heat a relatively thin and confined layer of powder. The confined layer of build material may also result in reduced energy drag, compared to when no confined layer is formed using a conveyor as disclosed herein, as any powder block created in front of the recoater due to the surplus of powder not used in the layer is minimized.

By controlling the temperature of the material deposited on previous layers of material previously deposited on the print bed the thermal impact on the previous layer is reduced. Furthermore, the proposed apparatus performs continuous spreading that does not depend on the powder block size. Thus, extensibility may be attained and the proposed apparatus may be used with any surface of any print bed size. Further to that, the introduction of a powder spreading carriage allows for bi-directional powder deposition that may accelerate the formation of the build material layers on the print bed.

As the powder is preheated and homogeneously deposited on the print bed, this allows increasing the speed of the recoating process compared to when no apparatus is used and powder is directly deposited on the print bed. With the use of the proposed apparatus, less powder is lifted to form a powder block, if any at all. Furthermore, the thermal control allows for controlling any impact on the uniformity of the powder layer deposited and of any previously deposited layers.

By using the proposed apparatus, the material deposition is performed in a controlled manner. The quantity of the material deposition and the forming of the layer, i.e. the recoating process are performed in distinct processes. This allows for different materials to be used as each material may have a different behavior with particle sizes of different dimensions, geometries and thermal characteristics.

As the powder is preheated on the conveyor belt, mechanical handling of powder when the powder is in a heated or hot state is reduced. This allows working with highly pre-heated powder and minimizes less efficient heating systems once powder is already spread.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings), may be replaced by alternative features serving the same, equivalent or similar purpose, unless expressly stated otherwise.

Although a number of particular implementations and examples have been disclosed herein, further variants and modifications of the disclosed devices and methods are possible. As such, representative examples of the present disclosure have utility over a wide range of applications, and the above discussion is not intended and should not be construed to be limiting, but is offered as an illustrative discussion of aspects of the disclosure. Many variations are possible within the spirit and scope of the disclosure, which is intended to be defined by the following claims -- and their equivalents -- in which all terms are meant in their broadest reasonable sense unless otherwise indicated.

1. An apparatus to form a layer of build material on a print bed, comprising:
a conveyor, having an endless belt to transport build material onto the print bed,
a build material reservoir to deposit build material on the endless belt, in a build material receiving area of the conveyor,
a build material preheater to preheat build material transported by the endless belt in a build material preheating area of the conveyor.

2. The apparatus of claim 1, comprising
a spreading mechanism between the build material reservoir and the conveyor to uniformly deposit on the endless belt build material received from the build material reservoir.

3. The apparatus of claim 2, the spreading mechanism comprising a rotating screw spreader.

4. The apparatus of claim 2, the spreading mechanism comprising a vibrating platform.

5. The apparatus of claim 2, the spreading mechanism comprising a build material air fluidification mechanism.

6. The apparatus of claim 1, comprising
a build material transportation control blade, to control a quantity of build material passing from the build material receiving area to the build material preheating area of the conveyor.

7. The apparatus of claim 1, comprising a spreading control element to control spreading of the preheated build material on the printbed.

8. The apparatus of claim 1, mounted on a printer carriage.

9. The apparatus of claim 1, the build material reservoir comprising a dosage element to provide selected quantities of build material to the conveyor.

10. The apparatus of claim 1, the build material reservoir comprising a build material feeder to receive continuous build material from a central build material storage.

11. A 3D printing system comprising:
a build material reservoir; and
a build material spreader, having an endless conveyor platform to receive build material from the build material reservoir, preheat the build material and uniformly deposit the preheated build material as a layer on a print bed.

12. The 3D printing system according to claim 11, comprising a recoater to smooth the preheated build material deposited on the printbed.

13. The 3D printing system according to claim 11, comprising multiple build material spreaders arranged in line.

14. The 3D printing system according to claim 13, build material spreader to deposit preheated build material at a different area of the print bed at any given time.

15. A method of generating a layer of build material on a print bed, comprising:
providing build material on a conveyor moveable with respect to the print bed;
processing the build material on the conveyor to provide the build material in particulate form and at a desired temperature; and
depositing the processed build material as a layer along a width of the print bed.
